(19) United States
(12) Patent Application Publication
(10) Pub. No.: US 2009/0167966 A1
(43) Pub. Date: Jul. 2, 2009

(54) See-through display apparatus and method thereof

(75) Inventors: Dong-kyung NAM, Yonggin-si (KR); Hee-seob RYU, Suwon-si (KR); Ho-joon YOO, Seoul (KR); Chang-yeong KIM, Yonggin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/153,159

(22) Filed: May 14, 2008

(30) Foreign Application Priority Data
Jan. 2, 2008 (KR) 10-2008-0000360

(51) Int. Cl. G02F 1/1333; G02F 1/133

(52) U.S. Cl. 349/5; 349/16; 353/121

(57) ABSTRACT

A see-through display apparatus and a method thereof are provided. The see-through display apparatus includes: a screen which changes its transparency by varying its light scattering properties; a projector which projects an image onto the screen; and a control unit which controls a change of transparency of the screen. Accordingly, an image can be clearly displayed on the screen by controlling light scattering and non-scattering states of the screen, and also a user can monitor the external environment through the screen.

### CROSS REFERENCE TO RELATED APPLICATIONS

This application claims priority from Korean Patent Application No. 10-2008-0000360, filed on Jan. 2, 2008, the disclosure of which is incorporated herein in its entirety by reference.

### BACKGROUND OF THE INVENTION

1. Field of the Invention

The present invention relates to a see-though display apparatus and a method thereof, and more particularly, to a see-through display apparatus and a method thereof, which displays an image on a see-through screen.

2. Description of the Related Art

A see-through screen is visibly transparent, which enables a viewer to simultaneously see an image on the screen and objects through the screen. See-through screens are used in applications such as a head-up display (HUD) of an aircraft, a vehicle, and a ship, a head mount display (HMD), a window-type image display, a transparent TV, and a transparent monitor.

However, as the transparency of a see-through screen increases, image quality becomes lower, and conversely, as the image quality increases, the transparency becomes lower, and thus the viewer cannot see through the screen.

### SUMMARY OF THE INVENTION

Therefore, to solve the above problems in the conventional arts, it is an object of the present invention to provide a see-through display apparatus and a method thereof, which can provide high image quality and high transparency.

To accomplish the above object of the present invention, the present invention provides a see-through display apparatus and a method thereof, which displays an image on a screen which changes transparency by varying light scattering properties.

Additional aspects of the invention will be set forth in the description which follows, and in part will be apparent from the description, or may be learned by practice of the invention.

The present invention discloses a see-through screen device including: a screen whose transparency is changed by varying light scattering properties; and a control unit which controls a change of transparency of the screen.

The screen may be formed of polymer dispersed liquid crystal (PDLC), whose state shifts between a light scattering state and a light non-scattering state according to an orientation direction of anisotropic liquid crystal. The control unit may change the state of the screen periodically between the light scattering state and the light non-scattering state. The control unit may vary sections of the light scattering state and the light non-scattering state.

The present invention also discloses a see-through display apparatus including: a screen whose transparency is changed by varying light scattering properties of the screen; a projector which projects an image onto the screen; and a control unit which controls a change of transparency of the screen.

The control unit may control a brightness of a lamp of the projector according to the light scattering state and the light non-scattering state of the screen. The control unit may control a brightness of the image projected onto the screen by opening or shutting a shutter of the projector according to the light scattering state and the light non-scattering state of the screen. The shutter of the projector may be an electric shutter or mechanical shutter.

The present invention also discloses a method of displaying an image projected from a projector onto a screen, whose state shifts between a light scattering state and a light non-scattering state, the method including: determining a cycle of the light scattering state and the light non-scattering state of the screen; and varying the light scattering state and the light non-scattering state of the screen according to the determined cycle and projecting the image from the projector while the screen is in the light scattering state.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 shows a structure of a see-through display apparatus according to an embodiment of the present invention.

FIGS. 2A and 2B show a light scattering state and a light non-scattering state of a screen in FIG. 1.

FIG. 3A illustrates a projector according to an embodiment of the present invention.

FIG. 3B illustrates a projector according to another embodiment of the present invention.

FIG. 4 is a block diagram showing a structure of a control unit according to an embodiment of the present invention.

FIGS. 5A and 5B respectively show a screen control signal and a projector control signal according to an embodiment of the present invention.

FIG. 6 is a flowchart illustrating a method of displaying an image projected from a projector onto a screen, whose state shifts between a light scattering state and a light non-scattering state, according to an embodiment of the present invention.

FIG. 7 is a flowchart illustrating a method of determining a cycle of the light scattering state and the light non-scattering state of the screen, according to an embodiment of the present invention.

### DETAILED DESCRIPTION OF EXEMPLARY EMBODIMENTS

The invention is described more fully hereinafter with reference to the accompanying drawings, in which exemplary embodiments of the invention are shown. Hereinafter, in describing the present invention, detailed descriptions of relevant functions or structures well-known to those skilled in the art will be omitted when it is considered that the descriptions obscure the point of the present invention. The terms used herein are defined in consideration of the functions of elements in the present invention, and may be varied according to the intentions or the customs of a user and an operator.

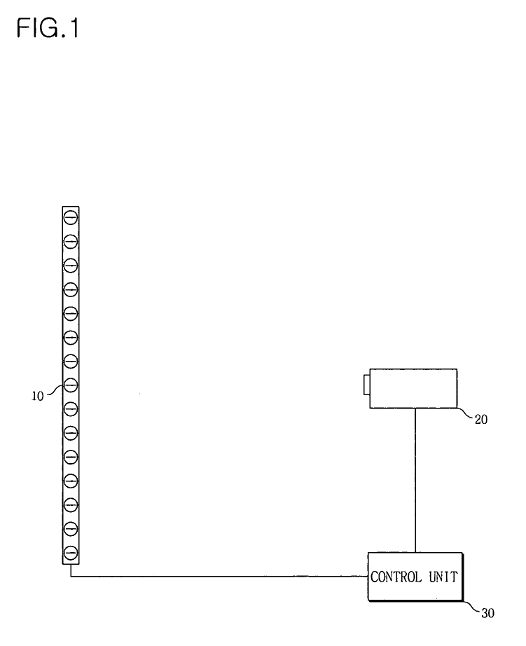

FIG. 1 shows a structure of a see-through display apparatus according to an embodiment of the present invention. Referring to FIG. 1, the see-through display apparatus includes a screen 10, a projector 20, and a control unit 30.

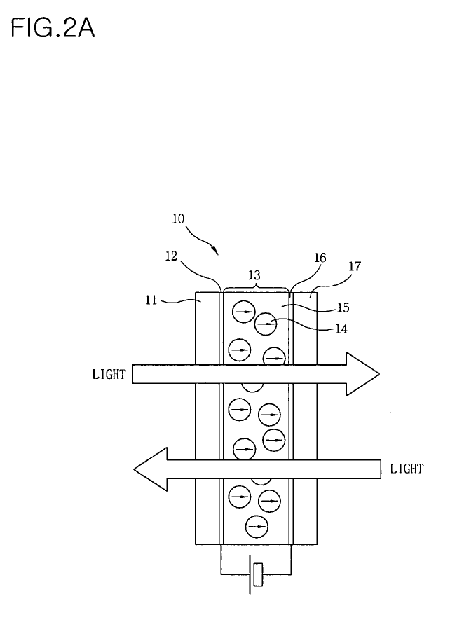

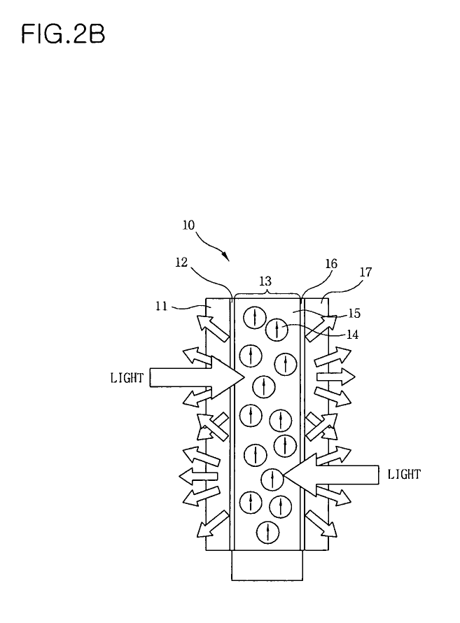

The screen 10 changes its transparency by varying light scattering properties. That is, an orientation direction of anisotropic liquid crystal of the screen 10 is changed in response to an electric signal, and a state of the screen 10 changes between a light scattering state (an opaque state) and a light non-scattering state (a transparent state) according to the orientation direction of the liquid crystal. The screen 10 is formed of polymer dispersed liquid crystal (PDLC). The light scattering and light non-scattering states of the screen 10 are controlled by the control unit 30, which will be described later with reference to FIGS. 2A and 2B.

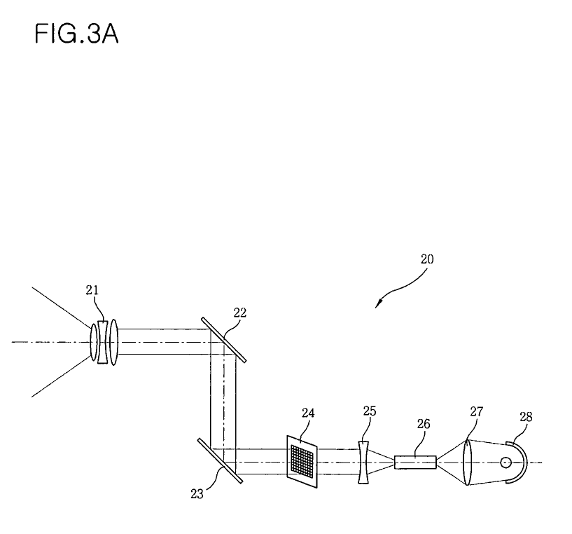

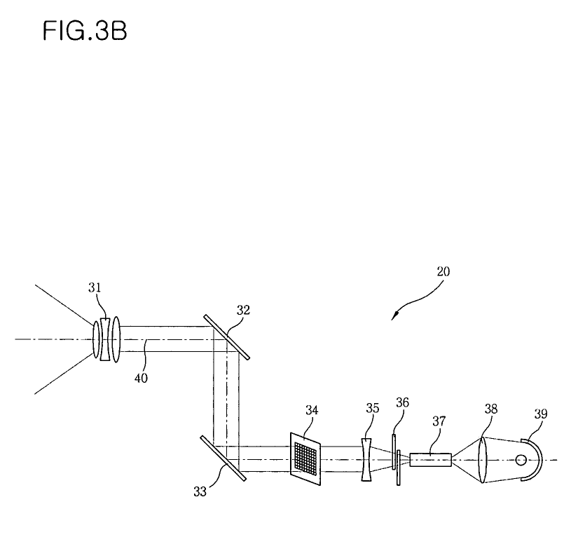

The projector 20 projects an image onto the screen 10 during a light scattering state of the screen 10, and does not project the image onto the screen 10 during a light non-scattering state. That is, the projector 20 can adjust the brightness of a lamp or the brightness of the image projected onto the screen 10 according to the state of the screen 10 between the light scattering state and the light non-scattering state. The projection of the image by the projector 20 is controlled by the control unit 30, which will be described later with reference to FIGS. 3A and 3B.

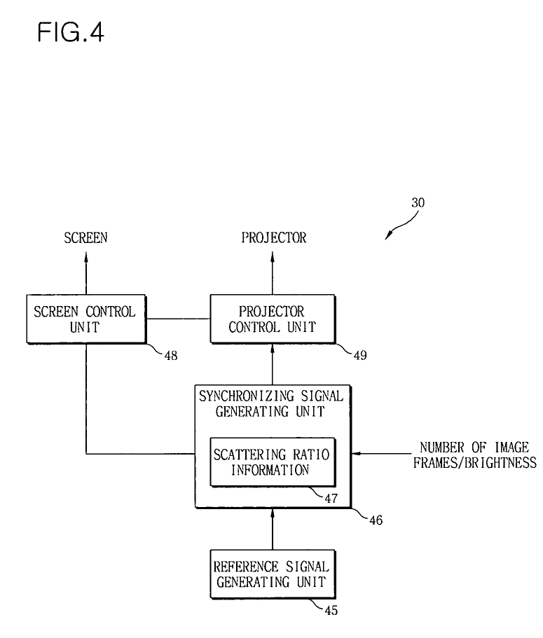

The control unit 30 periodically changes the state of the screen 10 between the light scattering state and the light non-scattering state, and controls the projector 20 to project an image in synchronization with the light scattering state and light non-scattering state of the screen 10. That is, the control unit 30 controls the projector 20 to project the image onto the screen 10 during the light scattering state of the screen 10, and controls the projector 20 not to project the image onto the screen 10 during the light non-scattering state of the screen 10. Here, on the screen 10, a duration of the light scattering state and a duration of the light non-scattering state may vary according to the number of image frames and brightness. The operation of the control unit 30 will be described later in detail with reference to FIG. 4.

FIGS. 2A and 2B show a light scattering state and a light non-scattering state of the screen 10 in FIG. 1. Referring to FIGS. 2A and 2B, the screen 10 may include glass substrates 11 and 17, electrode panels 12 and 16 respectively formed on the glass substrates 11 and 17, and polymer dispersed liquid crystal (PDLC) 14 inserted in a space between the glass substrates 11 and 17. The electrode panels 12 and 16 may be indium thin oxide (ITO) electrode panels.

The PDLC 14 consists of liquid crystal 14 and polymer 15, and the liquid crystal 14 is dispersed in the polymer 15. The liquid crystal 14 is an anisotropic liquid crystal with birefringence properties, and has a refraction index which varies according to the orientation direction of the liquid crystal 14. For example, when the liquid crystal 14 is laid in a horizontal direction as shown in FIG. 2A, a refraction index of the liquid crystal may be 1.5, and when the liquid crystal 14 is in a vertical direction as shown in FIG. 2B, the refraction index may be 1.7.

Therefore, first, a refraction index of the polymer 15 is made identical with either a vertical direction refraction index or a horizontal direction refraction index of the liquid crystal 14. Then, the screen 10 becomes either transparent or opaque depending on the orientation direction (horizontal or vertical direction) of the liquid crystal 14. For example, if the refraction index of the polymer 15 is identical with the horizontal direction refraction index of the liquid crystal and the liquid crystal 14 is placed in a horizontal direction, the screen 10 becomes transparent. On the other hand, when the liquid crystal 14 is laid in a vertical direction, the refraction index of the polymer 15 is changed. Accordingly, the liquid crystal 14 evenly scatters visible light, so that the screen 10 becomes opaque. Hereinafter, it is assumed that the refraction index of the polymer 15 is identical with the vertical direction refraction index of the liquid crystal 14.

The liquid crystal 14 goes into a light scattering state or non-scattering state according to whether or not voltage is applied, and consequently, the screen 10 with the structure described above becomes transparent or opaque depending on the state of the liquid crystal 14. In other words, when a voltage is applied to the electrode panels 12 and 16 from the control unit 30 as illustrated in FIG. 2A, the screen 10 becomes transparent. As the result, the screen 10 lets the light projected from the projector 20 pass through the screen 10, and, therefore, an image cannot be created thereon. Alternatively, the screen 10 becomes opaque when a voltage is not applied to the electrode panels 12 and 16 from the control unit 30 as illustrated in FIG. 2B. Thus, the screen 10 scatters the light projected from the projector 20 to create an image.

FIG. 3A shows a structure of a projector 20 according to an embodiment of the present invention, and FIG. 3B shows a structure of the projector 20 according to another embodiment of the present invention. Referring to FIG. 3A, the projector 20 includes an enlarging optical system 21, mirrors 22 and 23, an image creating device 24, a collimator 25, a light diffusing and transmitting device 26, a light condensing device 27, and a lamp 28.

The lamp 28 is a light source such as a strobe light, laser, or a light emitting diode. The lamp 28 may be lit on and off in synchronization with the light scattering and non-scattering states of the screen 10, which are alternately repeated at intervals of 30 to 60 ms. The reason for using such a lamp is based on persistence of vision. Characteristics of persistence of vision are determined by the intensity of light (lux), light exposure time, and wavelength, and each individual has different characteristics of persistence of vision. If image frames are displayed on a screen at intervals of about 30 to 60 ms, human vision does not recognize persistence of image frames. Therefore, the screen 10 should repeatedly shift between the light scattering state and the light non-scattering state at intervals of 30 to 60 ms, and thus the image needs to be projected to the screen 10 within an interval of 30 to 60 ms. To this end, a light source is required, which can light on and off within an interval of 30 to 60 ms. Accordingly, a strobe lamp, laser, or an LED may be employed for the lamp 28 as a light source.

The light produced from the lamp 28 is transmitted to the image creating device 24, passing through the light condensing device 27, the light diffusing and transmitting device 26, and the collimator 25. The image creating device 24 creates an image from image frames by using the transmitted light. The image creating device 24 may be a liquid crystal display (LCD) image creating device, or a liquid crystal on silicon (LCoS) image creating device, which can represent gradation at high speed within 30 to 60 ms by using a magnitude of an applied voltage. A series of image frames should be displayed on the screen 10 at intervals of 30 to 60 ms so that human vision cannot recognize persistence of images. A digital micro-mirror device (DMD), which performs micro mirror switching to represent colors and gradations, is not suitable as the image creating device 24 since a great amount of high-speed micro mirror switching is required to fully represent gradation within intervals of 30 to 60 ms.

The image created by the image creating device 24 is projected to the screen 10 through the mirrors 22 and 23 and the enlarging optical system 21.

A structure of a projector 20 according to another embodiment of the present invention will now be described with reference to FIG. 3B. Referring to FIG. 3B, the projector 20 includes an enlarging optical system 31, mirrors 32 and 33, an image creating device 34, a collimator 35, a shutter 36, a light diffusing and transmitting device 37, a light condensing device 38, and a lamp 39. The shutter 36 may be disposed at a predetermined position on an optical path 40. The shutter 36 is open only when the screen 10 is in a light scattering state, thereby enabling the image created by the image creating device 34 to be projected on the screen 10. That is, the shutter 36 is open or shut under the control of the control unit 30 to allow the created image to be projected on the screen 10 or not. In this case, the shutter 36 may be formed as an electric shutter using an LCD or a mechanical shutter using a compact motor. Other than the structure of the shutter 36, the structures of the other elements of the projector 20 in FIG. 3B are the same as those in FIG. 3A, and thus their descriptions will not be repeated.

FIG. 4 is a block diagram of the control unit 30 ofthe see-through display apparatus in FIG. 1. Referring to FIG. 4, the control unit 30 includes a reference signal generating unit 45, a synchronizing signal generating unit 46, a screen control unit 48, and a projector control unit 49. The reference signal generating unit 45 may be formed of a crystal oscillator, and generates a reference signal having a predetermined frequency. For example, the reference signal may have a frequency of 1 KHz.

The synchronizing signal generating unit 46 generates a synchronizing signal based on the number of image frames and brightness, and transmits the generated synchronizing signal to the screen control unit 48 and the projector control unit 49. More specifically, the synchronizing signal generating unit 46 determines a cycle of the synchronizing signal using the number of image frames, and determines a duty ratio of the determined cycle using scattering ratio information 47 in accordance with the predetermined brightness. The cycle of the synchronizing signal based on the number of the image frames becomes 33 ms when an image of 30 frames per second is displayed. In this case, the cycle of the reference signal is 1 ms (=1/1 KHz).

The scattering ratio information 47 in accordance with the brightness indicates the ratio of the light scattering state and the light non-scattering state of the screen 10 in the determined cycle, and can vary according to the brightness around the see-through display apparatus in FIG. 1. For example, since at night an image projected onto the screen 10 looks brighter than usual due to dark surroundings, the duty ratio of the light scattering state may be reduced to increase transparency of the screen 10. On the other hand, since in the day an image projected onto the screen 10 appears dimmer due to bright surroundings, the duty ratio of the light scattering state may be increased to reduce the transparency of the screen 10. In this case, the brightness may be measured and provided by a brightness measuring device, or a user may set the brightness manually.

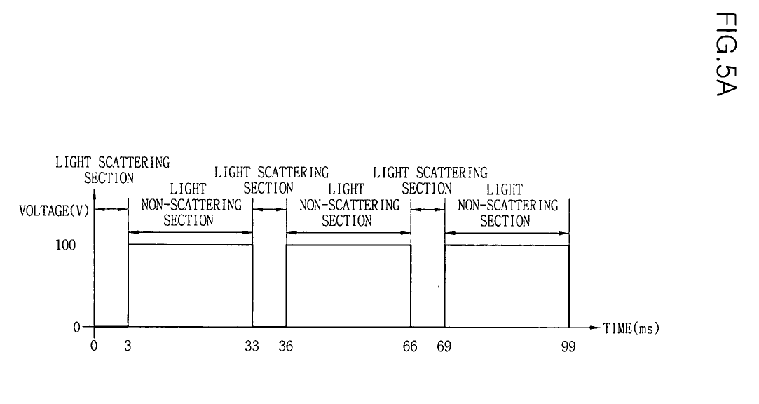

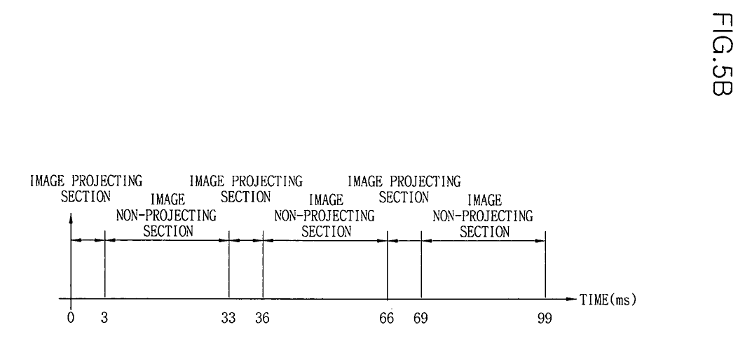

The screen control unit 48 controls the light scattering and light non-scattering states of the screen 10 by using the synchronizing signal received from the synchronizing signal generating unit 46. The projector control unit 49 controls the brightness of the image projected onto the screen 10. A signal for controlling the light scattering state and non-scattering states of the screen 10 is illustrated in FIG. 5A, and a signal for controlling the brightness of the image projected from the projector 20 is illustrated in FIG. 5B.

FIG. 5A illustrates a screen control signal according to an embodiment of the present invention. As shown in FIG. 5A, the screen control signal has a cycle of 33 ms, and a duty ratio of the light scattering state section to the light non-scattering state section is 1/10. Thus, in a cycle of 33 ms, the screen 10 stays in the light scattering state for 3 ms, and stays in the light non-scattering state for 30 ms. Hence, the transparency of the screen 10 is increased.

FIG. 5B is a projector control signal according to an embodiment of the present invention. As shown in FIG. 5B, the projector control signal has a cycle of 33 ms, and there is a phase difference of 180 degrees between the project control signal and the screen control signal. That is, the projector 20 projects an image onto the screen 10 when it is in the light scattering state in response to the projector control signal, and stops projecting the image when the screen 10 is in the light non-scattering state. The reason that the projector 20 does not project the image onto the screen 10 during the light non-scattering state is that the image could be focused on an undesired place.

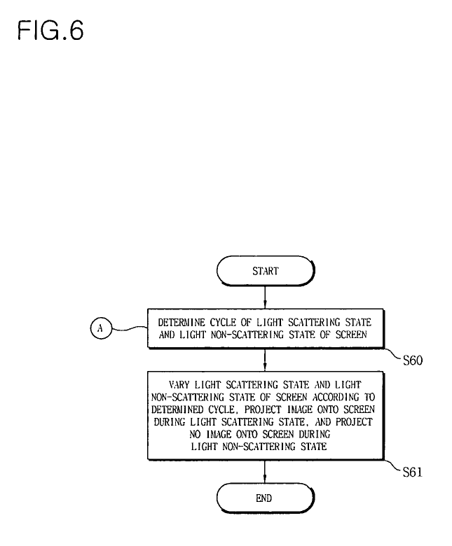

FIG. 6 is a flowchart illustrating a method of displaying an image projected from a projector onto a screen whose state shifts between a light scattering state and a light non-scattering state, according to an embodiment of the present invention. Referring to FIG. 6, the method for displaying the image on the screen comprises determining a cycle of the states of the screen, changing a state of the screen between the light scattering state and the light non-scattering state, and projecting an image from the projector onto the screen during the light scattering state.

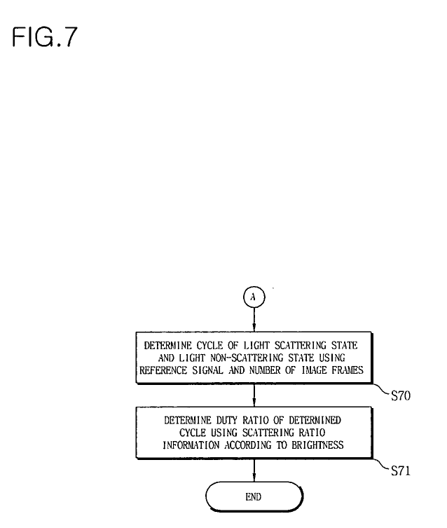

A control unit determines a cycle of the light scattering and light non-scattering states of the screen with reference to the number of image frames and the brightness (operation S60). With reference to FIG. 7, operation S60 will now be described in detail. As shown in FIG. 7, the control unit determines the cycle of the light scattering state and the light non-scattering state of the screen using the reference signal and the number of image frames (operation S70). Then, the control unit determines a duty ratio of the determined cycle using predetermined scattering ratio information according to the brightness (operation S71). The image is either projected or not projected onto the screen according to the states of the screen.

The scattering ratio information according to the brightness indicates the ratio of the light scattering state section to the light non-scattering state section in the predetermined cycle, and may vary according to the brightness of surroundings of the see-through display apparatus in FIG. 1. The brightness may be measured and provided by an additional brightness measuring device, or a user may set the brightness manually.

The screen switches between the light scattering state and the light non-scattering state under the control of the control unit. The projector either projects or does not project the image onto the screen according to the control of the control unit. That is, the projector projects the image onto the screen when the screen is in the light scattering state. Thus, the image from the projector is displayed on the screen.

According to the present invention, a see-through display apparatus includes a screen which changes its transparency by varying its light scattering properties, a projector which projects an image onto the screen, and a control unit which controls the change of the transparency of the screen. Thus, the image can be clearly displayed on the screen by changing the state of the screen according to the number of image frames and changes in the brightness, and simultaneously, a user can see objects through the screen clearly.

Therefore, the see-through display apparatus and the method thereof according to the present invention can be used in applications that allow a user to monitor a background scene through the screen while viewing an image displayed on a screen. The applications may include an HUD and an HMD which are used in aircraft, vehicles, and ships.

That is, an HUD employing the see-through display apparatus and method according to the present invention enables a user to view navigation information as well as to monitor the outside at the same time while controlling the aircraft, vehicle, or ship. Also, an HMD employing the see-through display apparatus and method according to the present invention allows the user to monitor the external environment when wearing the HMD, unlike a closed HMD.

Moreover, since the see-through display apparatus and the method thereof according to the present invention uses a see-through screen which is easy to scale up, it may be applied to an electric image display appliance such as a wide television or a monitor, or to a window type image display which represents a floating object.

A see-through screen device according to an embodiment of the present invention may include a screen, which changes its transparency by varying its light scattering properties, and a control unit, which controls the changes in transparency of the screen. Unlike the see-through display apparatus according to the present invention, the see-through screen device does not include a projector which projects an image onto the screen. Therefore, an image can be clearly displayed on the screen regardless of a kind of a projector by controlling light scattering and non-scattering states of the screen, and also the user can monitor the external environment through the screen.

The screen of the see-through screen device may be formed of PLDC, whose state shifts between a light scattering state and a light non-scattering state according to an orientation direction of anisotropic liquid crystal having birefringent properties. The control unit determines a cycle of a light scattering state and a light non-scattering state and sections of the light scattering state and the light non-scattering state, using the number of image frames and the brightness, to control the screen to be transparent or opaque. More specifically, the control unit uses the number of image frames to determine the cycle of the light scattering state and the light non-scattering state, and determines the sections of the light scattering state and the light non-scattering state in accordance with predetermined scattering ratio information according to the brightness, in order to control states of the screen.

In addition, the see-through screen device according to the embodiment of the present invention may be applied to applications which allow a user to monitor the external environment through the screen while viewing an image on the screen. In particular, regardless of a kind of projector which projects an image onto the screen, such applications may include an HUD and HMD which are used for aircraft, vehicles, and ships.

That is, the HUD employing the see-through screen device according to the embodiment of the present invention enables a user to monitor navigation information and the external environment simultaneously while controlling an aircraft, a vehicle, or a ship. Also, an HMD employing the see-through screen device according to the embodiment of the present invention allows a user to easily view the external environment when wearing the HMD, unlike a closed HMD.

Furthermore, since the see-through screen device according to the embodiment of the present invention uses a see-through screen which is easy to be scaled up, it can be used for an electric image display appliance such as a television or a monitor, and also for a window type image display that represents a floating object.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A see-through screen device including:
a screen whose transparency is changed by varying light scattering properties of the screen; and
a control unit which controls a change of transparency of the screen.

2. The see-through screen device of claim 1, wherein the screen is formed of polymer dispersed liquid crystal (PDLC), whose state shifts between a light scattering state and a light non-scattering state according to an orientation direction of anisotropic liquid crystal.

3. The see-through screen device of claim 1, wherein the control unit changes the state of the screen periodically between the light scattering state and the light non-scattering state.

4. The see-through screen device of claim 3, wherein the control unit varies sections of the light scattering state and the light non-scattering state.

5. The see-through screen device of claim 4, wherein the control unit determines a cycle of the light scattering state and the light non-scattering state and durations of the light scattering state and the light non-scattering state by means of the number of image frames and brightness.

6. A see-through display apparatus including:
a screen whose transparency is changed by varying light scattering properties of the screen;
a projector which projects an image onto the screen; and
a control unit which controls a change of transparency of the screen.

7. The see-through display apparatus of claim 6, wherein the screen is made of PDLC, whose state shifts between a light scattering state and a light non-scattering state according to an orientation direction of anisotropic liquid crystal.

8. The see-through display apparatus of claim 6, wherein the control unit changes a state of the screen periodically between a light scattering state and a light non-scattering state.

9. The see-through display apparatus of claim 8, wherein the control unit varies durations of the light scattering state and the light non-scattering state.

10. The see-through display apparatus of claim of claim 8, wherein the control unit determines a cycle of the light scattering state and the light non-scattering state and sections of the light scattering state and the light non-scattering state by means of the number of image frames and brightness.

11. The see-through display apparatus of claim 6, wherein the control unit controls a brightness of a lamp of the projector according to the light scattering state and the light non-scattering state of the screen.

12. The see-through display apparatus of claim 6, wherein the control unit controls a brightness of the image projected onto the screen by opening or shutting a shutter of the projector according to the light scattering state and the light non-scattering state of the screen.

13. The see-through display apparatus of claim 12, wherein the shutter of the projector is an electric shutter or mechanical shutter.

14. A method of displaying an image projected from a projector onto a screen, whose state shifts between a light scattering state and a light non-scattering state, the method including:
determining a cycle of the light scattering state and the light non-scattering state of the screen; and
varying the light scattering state and the light non-scattering state of the screen according to the determined cycle and projecting the image from the projector while the screen is in the light scattering state.

15. The method of claim 14, wherein the determining ofthe cycle ofthe light scattering state and the light non-scattering state includes varying sections of the light scattering state and the light non-scattering state of the screen.

16. The method of claim 14, wherein when the sections of the light scattering state and the light non-scattering state are varied, the cycle of the light scattering state and the light non-scattering state and the sections of the light scattering state and the light non-scattering state are determined with reference to the number of image frames and brightness.

17. The method of claim 14, wherein the projecting of the image from the projector includes controlling a brightness of a lamp of the projector according to the light scattering state and the light non-scattering state of the screen.

18. The method of claim 14, wherein the projecting of the image from the projector includes controlling a brightness of the projected image by opening and shutting a shutter of the projector according to the light scattering state and the light non-scattering state.
